(19) United States
(12) Patent Application Publication
(10) Pub. No.: US 2025/0309436 A1
(43) Pub. Date: Oct. 2, 2025

(54) CELL PACK

(71) Applicant: Zhejiang Jinko Energy Storage Co., Ltd., Haining City (CN)

(72) Inventors: Yuanfu LV, Haining City (CN); Guochao CHEN, Haining City (CN); Yuanhang CHEN, Haining City (CN); Yanyan SHI, Haining City (CN)

(21) Appl. No.: 18/922,331

(22) Filed: Oct. 21, 2024

(30) Foreign Application Priority Data
Mar. 29, 2024 (CN) 202410379948.6
Jul. 2, 2024 (CN) 202410878824.2

(51) Int. Cl. H01M 50/242; H01M 50/124; H01M 50/244; H01M 50/264; H01M 50/502

(52) U.S. Cl. CPC H01M 50/242; H01M 50/1245; H01M 50/244; H01M 50/264; H01M 50/502

(57) ABSTRACT

A cell pack is provided, including a plurality of cell assemblies, and at least one cells contact system assembly. Each cell assembly of the plurality of cell assemblies includes cells arranged in a first direction, and each cell of the cells has a top surface, a bottom surface and side surfaces of the cell, each of the side surfaces adjoining the top surface and the bottom surface, each of the bottom surface and the side surfaces being provided with a protective film. A top of each cell assembly has a first region and second regions corresponding to protective films on outward-facing side surfaces of the cells. At least one CCS assembly is respectively disposed on the top of at least one cell assembly, where each respective CCS assembly includes a first portion located at least partially on the first region and second portions.

### CROSS REFERENCE TO RELATED APPLICATIONS

The present disclosure claims the benefit of priority under the Paris Convention to Chinese Patent Application No. 202410379948.6 filed on Mar. 29, 2024, and to Chinese Patent Application No. 202410878824.2 filed on Jul. 2, 2024, each of which is incorporated herein by reference in its entirety.

### TECHNICAL FIELD

The various embodiments described in this document relate in general to the technical field of energy storage, and more specifically to a cell pack.

### BACKGROUND

For current cell assemblies, it is generally necessary to provide a protective film on a surface of the cell assembly. The protective film is an insulating protective material, also known as an isolation film or anti-adhesive film. The protective film is used to separate multiple cells from one another, to reduce the impact of various faults of a single cell on other cells, and avoid damage to all the cells. At least one cells contact system (CCS) assembly is generally disposed above the cell assemblies and forms a cell pack with the cell assemblies.

At present, in order to avoid damage to the protective film wrapping the cell assemblies, a length of the CCS assembly is generally extended to cover the protective film. However, such CCS assembly is prone to rubbing with the protective film during installation, such that the protective film is still susceptible to scratches or collisions.

### SUMMARY

Embodiments of the present disclosure provide a cell pack.

According to some embodiments of the present disclosure, a cell pack is provided. The cell pack includes a plurality of cell assemblies, and at least one cells contact system (CCS) assembly. Each cell assembly of the plurality of cell assemblies includes cells arranged in a first direction, and each cell of the cells has a top surface, a bottom surface, and side surfaces of the cell, each of the side surfaces adjoining the top surface and the bottom surface, each of the bottom surface and the side surfaces being provided with a protective film. A top of each cell assembly has a first region corresponding to the top surfaces of the cells and second regions corresponding to edges of protective films on outward-facing side surfaces of the cells, the first region having two opposite edges extending in the first direction and two opposite edges extending in a second direction, each of the second regions abutting a respective edge of the first region. The first direction traverses the second direction. The at least one CCS assembly is respectively disposed on the top of at least one cell assembly of the plurality of cell assemblies, where each respective CCS assembly of the at least one CCS assembly includes a first portion located at least partially on the first region of a respective cell assembly of the at least one cell assembly and second portions, a respective second portion of the second portions corresponds to a respective second region of the second regions of the respective cell assembly and extends from a corresponding edge of the first portion in a direction away from at least one respective protective film in the respective second region, and an orthographic projection of the respective second portion on the respective second region covers the respective second region.

In some embodiments, the respective second portion is spaced apart from the at least one respective protective film exposed in the respective second region.

In some embodiments, the respective second portion includes: a cornice portion having an end connected to the corresponding edge of the first portion, where an orthographic projection of the cornice portion on the respective second region covers the at least one respective protective film exposed in the respective second region.

In some embodiments, a length of the orthographic projection of the cornice portion on the respective second region in the second direction is in a range of 0.2 mm to 1.8 mm.

In some embodiments, an angle between a surface of the cornice portion facing the at least one respective protective film and a surface of the at least one respective protective film facing the cornice portion is an acute angle.

In some embodiments, at least one step is formed between the cornice portion and the first portion.

In some embodiments, the cornice portion has a first connection portion and a second connection portion, and each of the first connection portion and the second connection portion has two opposite ends, where the first connection portion has an end connected to the first portion and extending in a direction perpendicular to the top of the cell assembly, and the first connection portion has another end connected to an end of the second connection portion, and the second connection portion extends in the first direction. An orthographic projection of the second connection portion on the at least one respective second region covers the respective protective film exposed in the respective second region.

In some embodiments, the second portion further includes: an extension portion connected to another end of the cornice portion away from the first portion, where the extension portion extends in a direction from the top surface to the bottom surface of the cell, and the extension portion is spaced apart from the at least one respective protective film exposed in the respective second region.

In some embodiments, the extension portion is spaced apart from the at least one respective protective film by a distance in a range of 0.5 mm to 1 mm.

In some embodiments, the cell pack further includes: at least one fastener disposed on an outer side of the plurality of cell assemblies and configured for fixing the plurality of cell assemblies, where a spacing between the extension portion and the at least one protective film exposed in the respective second region is less than a thickness of a respective fastener of the at least one fastener.

In some embodiments, the extension portion abuts on a top surface of a corresponding fastener at an end of the extension portion away from the cornice portion.

In some embodiments, the extension portion defines at least one through hole on a surface of the extension portion facing the at least one respective protective film.

In some embodiments, the first portion and the second portions are integrally formed.

In some embodiments, the second portion has a thickness in a range of 0.3 mm to 0.8 mm.

In some embodiments, the cell pack further includes: a bottom plate having opposing first side edges and opposing second side edges, where each first side edge is connected between the second side edges; and four side plates connected sequentially, where each side plate is connected with the corresponding first side edge or second side edge, and the four side plates and the bottom plate define an accommodating cavity, where each cell assembly is located in the accommodating cavity, and each side plate has a top surface lower than the top surfaces of the cells.

In some embodiments, the cell pack further includes: at least one fastener disposed on an outer side of the plurality of cell assemblies and configured for fixing the plurality of cell assemblies. Each side plate has a thickness less than or equal to a thickness of a respective fastener, and has a top surface not higher than a bottom surface of the respective fastener facing the side plate.

In some embodiments, each of the side plates or the bottom plate is a protective member undergoing an electrophoresis process; or each of the side plates or the bottom plate includes a protective member and an insulating film covering a surface of the protective member, the insulating film facing the cell assembly.

In some embodiments, the cell pack further includes: a housing provided with mounting beams at a base of the housing, where a mounting position is formed between each two mounting beams; end plates, where each end plate is provided at an end of a corresponding cell assembly of the plurality of cell assemblies, and is connected with a corresponding mounting beam at a bottom of the end plate so that a respective cell assembly is mounted at a respective mounting position, where at least part of a side wall surface of the cell assembly and the mounting beam form a first cushioning region, and at least part of a bottom surface of the cell assembly and the base form a second cushioning region; and at least one cushioning assembly, where a respective cushioning assembly of the at least one cushioning assembly is formed by extending from a bottom of the respective end plate, and the respective cushioning assembly includes a first cushioning plate and a second cushioning plate, where the second cushioning plate is bent and extends in a horizontal direction from an end of the first cushioning plate away from the end plate, the first cushioning plate is disposed in the first cushioning region in a vertical direction, and the second cushioning plate is disposed in the second cushioning region in a horizontal direction.

In some embodiments, the first cushioning plate and the second cushioning plate are straight plate structures, a corrugated plate structures, or a combination structure of a straight plate and a corrugated plate.

In some embodiments, a horizontal distance between an end of the first cushioning plate away from the second cushioning plate and the mounting beam is in a range of 0.5 mm to 2 mm.

### BRIEF DESCRIPTION OF THE DRAWINGS

One or more embodiments are illustrated by pictures in the accompanying drawings corresponding thereto, and these illustrative descriptions do not constitute a limitation of the embodiments. Unless otherwise stated, the figures in the accompanying drawings do not constitute a limitation of scale. In order to more clearly explain the technical solutions in the embodiments of the present disclosure or the conventional technology, the drawings that need to be used in the embodiments will be briefly introduced below, and it is obvious that the drawings in the following description are only some embodiments of the present disclosure. For those skilled in the art, other drawings can be obtained according to these drawings without making creative efforts.

FIG. 1 is a side view of a cell module.

FIG. 2 is a partially enlarged structural diagram of part M of the cell module in FIG. 1.

FIG. 3 is a side view of a cell module according to an embodiment of the present disclosure.

FIG. 4 is a partially enlarged structural diagram of part N of the cell module in FIG. 3.

FIG. 5 is another partially enlarged structural diagram of part N of the cell module in FIG. 3.

FIG. 6 is yet another partially enlarged structural diagram of part N of the cell module in FIG. 3.

FIG. 7 is a side view of another embodiment of FIG. 6.

FIG. 8 is a structural explosion diagram of a cell module according to an embodiment of the present disclosure.

FIG. 9 is a partial structural schematic diagram of a cell pack according to embodiments of the present disclosure.

FIG. 10 is a schematic structural diagram of an end plate of a cell pack according to embodiments of the present disclosure.

FIG. 11 is a schematic structural diagram of an end plate of the cell pack according to other embodiments of the present disclosure.

### DETAILED DESCRIPTION OF THE EMBODIMENTS

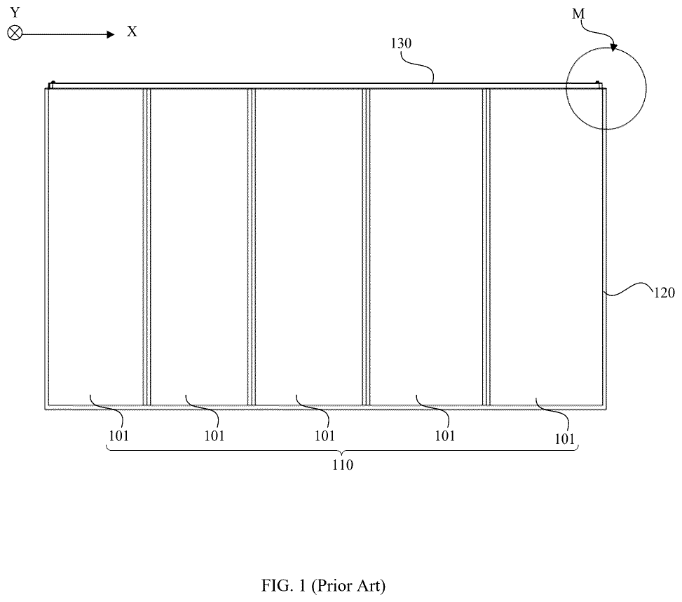

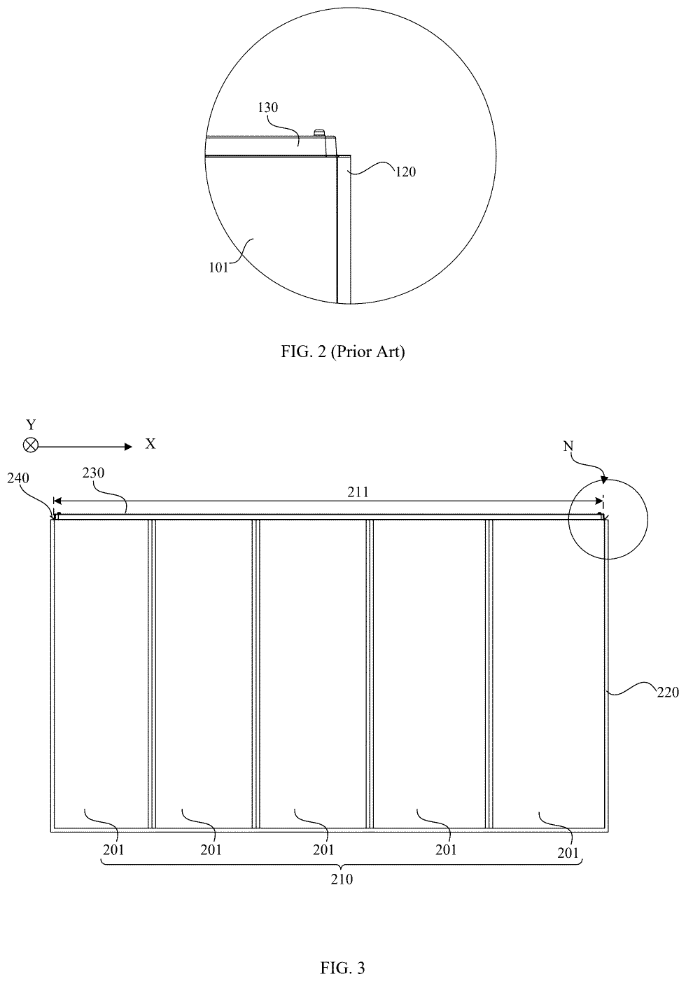

FIG. 1 is a side view of a cell module. FIG. 2 is a partially enlarged structural diagram of part M of the cell module in FIG. 1. Referring to FIGS. 1 and 2, the cell module includes at least one cell assembly 110. Each cell assembly 110 includes cells 101 arranged in a first direction X, and the cell 101 is provided with protective films 120 on a bottom surface and side surfaces of the cell 101. The protective film 120 is viewed from the top surface of the cell assembly 110. The cell module further includes a CCS assembly 130. The CCS assembly 130 is disposed on a top surface of the cell assembly 110. At present, in order to prevent a protective film 120 exposed in a second region from being damaged, a length of the CCS assembly 130 is generally extended to cover the protective film 120, but such CCS assembly 130 is prone to rubbing with a top of the protective film 120 during installation, such that the protective film 120 is still susceptible to scratches or collisions.

Embodiments of the present disclosure provide a cell module, which can prevent the protective film exposed in the second region from being scratched by the CCS assembly.

Hereinafter, embodiments of the present disclosure will be described in detail with reference to the accompanying drawings. However, one of ordinary skill in the art will appreciate that in various embodiments of the present disclosure, many technical details are set forth in order to better understand the present disclosure by the reader. However, even without these technical details and various changes and modifications based on the following embodiments, the technical solutions claimed by the present disclosure can be realized.

In the description of the embodiments of the present disclosure, the technical terms such as “first”, “second” and the like are only used to distinguish different objects, and could not be understood as indicating or implying relative importance or implicitly specifying the number, specific order, or primary-secondary relationship of the indicated technical features. In the illustration of the embodiments of the present disclosure, “a plurality of/multiple” means two or more unless otherwise explicitly and specifically defined.

Reference herein to an “embodiment” means that particular features, structures, or characteristic described in connection with the embodiments may be included in at least one embodiment of the present disclosure. The appearance of the phrase in various embodiments in the specification does not necessarily refer to the same embodiment, nor is it an independent or alternative embodiment that is mutually exclusive from other embodiments. It is explicitly and implicitly understood by those skilled in the art that the embodiments described herein may be combined with other embodiments.

In the illustration of the embodiments of the present disclosure, the term “and/or” is only an association relationship describing associated objects, and indicates that there may be three relationships, such as A and/or B, which may indicate that there is merely A, there are both A and B, and there is merely B. In addition, the character “/” herein generally indicates that the related objects between “/” are in an “or” relationship.

In the illustration of the embodiments of the present disclosure, the term “a plurality/multiple” refers to two or more (including two). Similarly, “a plurality of groups” refers to two or more groups (including two groups), and “a plurality of pieces” refers to two or more pieces (including two pieces).

In the illustration of the embodiments of the present disclosure, the technical terms, such as “center”, “longitudinal”, “transversal/horizontal”, “length”, “width”, “thickness”, “upper”, “lower”, “front”, “back”, “left”, “right”, “vertical”, “horizontal”, “top”, “bottom”, “inner”, “outer”, “clockwise”, “counterclockwise”, “axial”, “radial”, “circumferential” and the like are based on the orientation or positional relationships shown in the drawings, and are merely used to facilitate the description and simplify the description of the embodiments of the present disclosure, and do not indicate or imply that the referred device or element must have a specific orientation, be constructed and operated in a specific orientation, and therefore cannot be understood as a limitation of the embodiments of the present disclosure.

In the illustration of the embodiments of the present disclosure, unless otherwise explicitly specified and limited, technical terms such as “mounted”, “coupling/coupled”, “connected”, and “fixed” should be understood in a broad sense, for example, there may indicate a fixed connection, a detachable connection, or integrated formed. Alternatively, there may also indicate a mechanical connection or an electrical connection. Alternatively, there may indicate a directly connection or indirectly connection through an intermediate medium, or there may indicate the internal communication of two elements or the interaction between two elements. For those skilled in the art, the specific meanings of the above terms in the embodiments of the present disclosure can be understood according to specific circumstances.

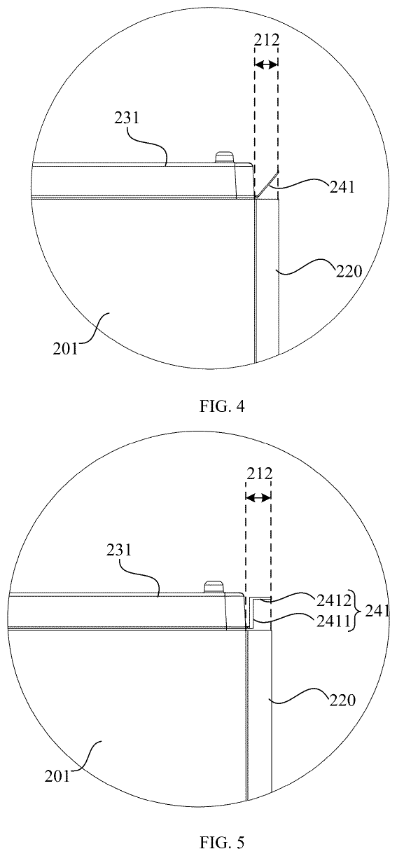

FIG. 3 is a side view of a cell module according to an embodiment of the present disclosure. FIG. 4 is a partially enlarged structural diagram of part N of the cell module in FIG. 3.

Referring to FIGS. 3 and 4, the cell module includes a plurality of cell assemblies 210 and at least one cells contact system (CCS) assembly 230. Each cell assembly 210 includes cells 201 arranged in a first direction X. Each cell 201 of the cells 201 is provided with protective films 220 on a bottom surface and side surfaces of the cell 201. The cell assembly 210 has a top surface, and the top surface includes a first region 211 and second regions 212 located on two opposite sides of the first region 211 along a second direction Y and located on two opposite sides of the first region 211 along the first direction X. The first direction X traverses the second direction Y. The first region 211 refers to a region including a top surface of each of the cells. The second regions 212 refer to regions where the protective films on outer side walls of the cell assembly constituted by the cells are located. The at least one CCS assembly 230 is respectively disposed on the top surface of at least one cell assembly 210 of the plurality of cell assemblies 210. Each CCS assembly 230 includes a first portion 231 at least partially located on the first region 211 and second portions 240. Each respective second portion 240 extends from a corresponding edge of the first portion 231 in a direction away from at least one respective protective film 220. An orthographic projection of each second portion 240 on a respective second region 212 covers the respective second region 212.

In some embodiments, the respective second portion 240 is spaced apart from the at least one respective protective film 220 exposed in the respective second region 212. The first direction X is a longitudinal direction of each cell assembly 210, and the second direction Y is a width direction of the cell assembly 210.

In other words, if there are the plurality of cell assemblies 210, each cell assembly 210 of the plurality of cell assemblies 210 includes cells 201 arranged in the first direction X, each cell 201 of the cells 201 has a top surface, a bottom surface, and side surfaces of the cell, each of the side surfaces adjoining the top surface and the bottom surface, each of the bottom surface and the side surfaces being provided with a protective film 220. A top of each cell assembly 210 has a first region 211 corresponding to the top surfaces of the cells 201 and second regions 212 corresponding to edges of protective films 220 on outward-facing side surfaces of the cells, the first region having two opposite edges extending in the first direction X and two opposite edges extending in a second direction Y, each of the second regions Y abutting a respective edge of the first region X. The first direction X traverses the second direction Y. The at least one CCS assembly 230 is respectively disposed on the top of at least one cell assembly 210 of the plurality of cell assemblies 210. Each respective CCS assembly 230 of the at least one CCS assembly 230 includes a first portion 231 located at least partially on the first region 211 of a respective cell assembly 210 of the at least one cell assembly 210 and second portions 240, a respective second portion 240 of the second portions 240 corresponds to a respective second region 212 of the second regions 212 of the respective cell assembly and extends from a corresponding edge of the first portion 231 in a direction away from at least one respective protective film 220 in the respective second region 212, and an orthographic projection of the respective second portion 240 on the respective second region 212 covers the respective second region 212.

With continued reference to FIG. 3, in the cell module provided in the embodiments of the present disclosure, the cell assembly 210 includes the cells 201 arranged in the first direction X, where each cell 201 is provided with the protective films 220 on the bottom surface and the side surfaces of the cell 201. The protective films 220 separate the cells 201 from each other, thereby avoiding the influence of various failures of a single cell 201 on other cells 201 and avoiding interference between the cells 201. The top surface of the cell assembly 210 includes the first region 211 and the second regions 212 located the two opposite sides of the first region 211 along the second direction Y and located the two opposite sides of the first region 211 along the first direction X, and the first direction X intersects with the second direction Y. The cell module further includes the at least one CCS assembly 230. Each CCS assembly 230 is disposed on the top surface of each of the at least one cell assembly 210. The CCS assembly 230 includes the first portion 231 at least partially located on the first region 211 and the second portions 240, and each second portion 240 extends from the edge of the first portion 231 in the direction away from the at least one respective protective film 220. The orthographic projection of the respective second portion 240 on the respective second region 212 covers the respective second region 212. The respective second portion 240 is spaced apart from the at least one respective protective film 220 exposed in the respective second region 212. It shall be understood that the first portion 231 may be a component having connection, support, and protection functions, and the first portion 231 may be connected with the cells 201 so that the cells 201 are assembled to form the cell assembly 210, thereby making the structure of the cell assembly 210 more stable. The first portion 231 is at least partially located on the first region 211, and may also provide shielding protection for the cell assembly 210 to prevent the cell assembly 210 from colliding with other external components. In some other embodiments of the present disclosure, the first portion 231 may also have conductivity, thereby realizing the electrical management of the cells 201 and improving the working efficiency of the cell assembly 210. The second portion 240 may be a component having a shielding protection function. Since the orthographic projection of the second portion 240 on the second region 212 covers the second region 212, the respective second portion 240 may cover the at least one respective protective film 220 exposed in the second region 212 to prevent the protective film 220 exposed in the second region 212 from being rubbed or collided with the other external components.

In some embodiments, each respective second portion 240 is spaced apart from the at least one respective protective film 220 exposed in the respective second region 212. Since the second portion 240 is spaced apart from the at least one protective film 220 exposed in the respective second region 212, during installation of the CCS assembly 230 and the cell assembly 210, the second portion 240 of the CCS assembly 230 does not come into contact with the protective film 220 exposed in the second region 212. Therefore, the second portion 240 does not rubble with the protective film 220 exposed in the second region 212. In this way, the protective film 220 exposed in the second region 212 can be avoided from being scratched by the second portion 240. In addition, the orthographic projection of the second portion 240 on the second region 212 covers the second region 212, which can also prevent the protective film 220 exposed in the second region 212 from being in contact with other external components, thereby further improving the stability of the cell assembly 210 wrapped by the protective film 220.

The first portion 231 of the CCS assembly 230 defines a plurality of mounting holes or is provided with a plurality of mounting protrusions, and the cells 201 are provided with mounting protrusions or define mounting holes (not shown), on the top surface of the cells 201 for mounting the CCS assembly 230 and the cell assembly 210 together, corresponding to the mounting protrusions or the mounting holes of the first portion 231 of the CCS assembly 230, so that the CCS assembly 230 can centrally manage or detect the cell assembly 210. In addition, when one of the cells 201 in the cell assembly 210 fails, the fault can be quickly located, such that the maintenance time and cost can be reduced. The first portion 231 may be made of a material such as copper, aluminum, or steel, so that the fabrication cost of the CCS assembly 230 can be low.

In some embodiments, the second portions 240 and the first portion 231 are integrally formed, or the second portions 240 and the first portion 231 are fixedly connected by welding or the like, so that the stability of the overall structure of the CCS assembly 230 is good. The CCS assembly can have a certain strength, thereby protecting the cell assembly 210 covered by the CCS assembly 230.

With continued reference to FIGS. 3 and 4, each cell 201 is provided with protective films 220 on the bottom surface and the side surfaces of the cell 201. The top surface of the cell assembly 210 has four side edges, and each of the protective films 220 at the four side edges of the cell assembly 210 is exposed to the respective second region 212 of the top surface of the cell assembly 210. In other words, the top surface of the cell assembly 210 includes the first region 211 and the second regions 212 surrounding the first region 211 in a circumferential direction of the cell assembly 210, and each second region is provided with a corresponding set of protective films 220 (at least one protective film 220). In a same cell assembly 210, the cell assembly 210 may also include cells 201 arranged in the second direction Y, or may include cells 201 arranged in the first direction X and the second direction Y. An arrangement manner of the cells 201 and the number of cells 201 may be designed according to actual needs. The protective films 220 are configured to separate the cells 201 from each other and avoid the influence of failure of a single cell 201 on other cells 201. The protective film 220 may be a polypropylene (PP) film, a polyimide (PI) film, or a silicone film.

In some embodiments, each second portion 240 includes a cornice portion 241. An end of the cornice portion 241 is connected to the edge of the first portion 231. An orthographic projection of the cornice portion 241 on the at least one protective film 220 (or on the second region) covers the at least one protective film 220 exposed in the second region 212. There is a gap between the cornice portion 241 and the protective film 220 exposed in the second region 212. During mounting of the CCS assembly 230 and the cell assembly 210, the cornice portion 241 does not come into contact with the protective film 220 exposed in the second region 212, it is possible to avoid that the protective film 220 and the CCS assembly 230 collide with each other during mounting, and prevent the protective film 220 from being scratched.

In addition, if the protective film 220 exposed in the second region 212 is damaged, it means that the protective film 220 on the side surface of the cell 201 is damaged, and thus, the cell 201 is also easily damaged due to damage of the protective film 220 on the side surface of the cell 201. The orthographic projection of the cornice portion 241 on the protective film 220 (or on the second region) covers the protective film 220 exposed in the second region 212, which can reduce the probability of damage to the protective film 220 and the cell 201, and ensure the safety of the cell assembly 210 during operation.

Furthermore, a length of the orthographic projection of the cornice portion 241 on the at least one protective film 220 (or on the second region) in the second direction Y may be set to be in a range of 0.2 mm to 1.8 mm, specifically, 0.2 mm to 0.6 mm, 0.6 mm to 1.0 mm, 1.0 mm to 1.4 mm, or 1.4 mm to 1.8 mm. Within this length range, on one hand, the orthographic projection of the cornice portion 241 on the protective film 220 can completely cover the protective film 220 exposed in the second region 212, which can shield and protect the protective film 220 and avoid damage to the protective film 220. On the other hand, the orthographic projection of the cornice portion 241 on the protective film 220 can be avoided from being too long in the second direction Y, which can reduce the volume of the second portion 240 and the manufacturing cost, thereby reducing the space occupied by the cell module and increasing the manufacturing cost.

In some embodiments, an angle between a surface of the cornice portion 241 facing the at least one protective film 220 and a surface of the at least one protective film 220 facing the second region 212 (or facing the cornice portion 241) is an acute angle, specifically, may be 15° ˜75°. For example, the angle is 15° ˜25°, 25° ˜35°, 35° ˜45°, 45° ˜55°, 55° ˜65°, or 65° ˜75°. Within this angle range, it is possible to ensure that there is a spacing between the cornice portion 241 and the protective film 220 exposed in the second region 212, so that the cornice portion 241 does not contact with the protective film 220 exposed in the second region 212 to generate friction. In addition, it is possible to ensure that the cornice portion 241 has a certain covering effect on the protective film 220 exposed in the second region 212, and to prevent the protective film 220 exposed in the second region 212 from being damaged.

In some embodiments, the cornice portion 241 and the first portion 231 may be connected by bolts, such that the angle between the surface of the cornice portion 241 facing the protective film 220 and the surface of the protective film 220 facing the second region 212 (or facing the cornice portion 241) may be changed according to actual operation requirements. When the angle between the surface of the cornice portion 241 facing the protective film 220 and the surface of the protective film 220 facing the second region 212 needs to be changed, the bolts can be loosened with a wrench. When the angle is adjusted to a desired angle, the bolts can be tightened.

FIG. 5 is another partially enlarged structural diagram of part N of the cell module in FIG. 3.

Referring in conjunction with FIGS. 3, 4, and 5, in some embodiments, a step is formed between the cornice portion 241 and the first portion 231. It shall be understood that when the cornice portion 241 and the first portion 231 constitute a step, there is still a spacing between the cornice portion 241 and the protective film 220 exposed in the second region 212. The cornice portion 241 has a first connection portion 2411 and a second connection portion 2412. Each of the first connection portion 2411 and the second connection portion 2412 has two opposite ends. An end of the first connection portion 2411 is connected to the first portion 231 and extends in a direction perpendicular to the first direction X (in a direction perpendicular to the top surface of the cell assembly 210), and another end of the first connection portion 2411 is connected to an end of the second connection portion 2412. The second connection portion 2412 extends in the first direction X. An orthographic projection of the second connection portion 2412 on the respective second region 212 can completely cover the at least one protective film 220 exposed in the respective second region 212. The first connection portion 2411 and the second connection portion 2412 are integrally formed, or the first connection portion 2411 and the second connection portion 2412 are fixedly connected by welding or the like. Therefore, the cornice portion 241 does not come into contact with the protective film 220 exposed in the second region 212, and there is still a spacing between the cornice portion 241 and the protective film 220 exposed in the second region 212, so that there is no friction between the cornice portion 241 and the protective film 220 exposed in the second region 212 during mounting of the CCS assembly 230 and the cell assembly 210, and the integrity of the protective film 220 exposed in the second region 212 can be ensured.

In some other embodiments of the present disclosure, the number of steps formed between the cornice portion 241 and the first portion 231 may be 1, 2, or 3, as long as it is ensured that the cornice portion 241 does not come into contact with the protective film 220 exposed in the second region 212, and there is the spacing between the cornice portion 241 and the protective film 220 exposed in the second region 212. In addition, a maximum distance between the cornice portion 241 and the first portion 231 in the direction perpendicular to the first direction X (in the direction perpendicular to the top surface of the cell assembly 210) needs to be avoided to be too large, so that the overall occupied space and volume of the cell module is not too large. The number of stages of steps formed between the cornice portion 241 and the first portion 231 and the height of each step may be provided according to the actual needs, which are not limited herein.

In addition, in some embodiments, a cross section of the cornice portion 241 in a direction perpendicular to the first direction X may have a shape such as an arch shape or an eave shape, as long as the cornice portion 241 does not come into contact with the protective film 220 exposed in the second region 212, and there is the spacing between the cornice portion 241 and the protective film 220 exposed in the second region 212.

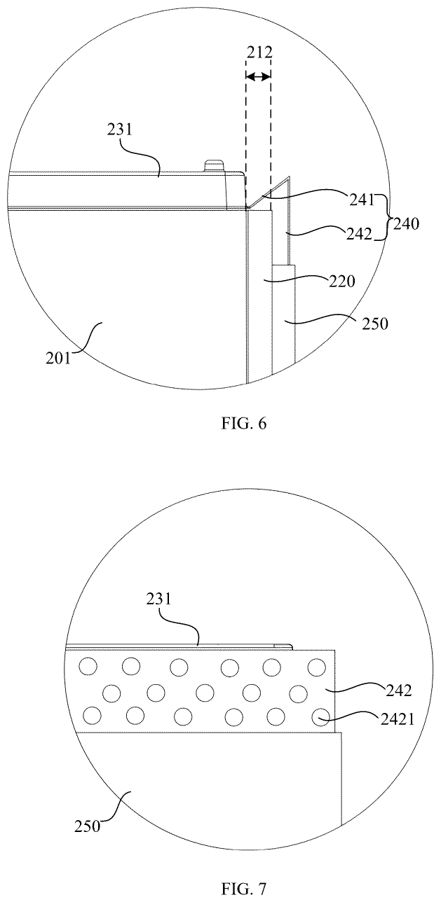

FIG. 6 is yet another partially enlarged structural diagram of part N of the cell module in FIG. 3.

Referring to FIGS. 3, 4, and 6, in some embodiments, each second portion 240 further includes an extension portion 242 connected to another end of the cornice portion 241 away from the first portion 231. The extension portion 242 extends in a direction from the top surface to the bottom surface of the cell 201 (in a direction perpendicular to the top surface of the cell 201). There is a gap between the extension portion 242 and the at least one protective film 220 located on the side wall of the cell assembly 210 (at least one protective film 220 exposed in the respective second region).

While extending in the direction from the top surface to the bottom surface of the cell 201, the extension portion 242 may also extend in a direction away from the protective film 220 located on the side wall of the cell 201, the gap between the extension portion 242 and the protective film 220 disposed on the side wall of the cell 201 in the direction from the top surface to the bottom surface of the cell 201 becomes larger and larger. Therefore, it is possible to ensure that the extension portion 242 covers the protective film 220 disposed on the side wall of the cell 201, to prevent the protective film 220 disposed on the side wall of the cell 201 from being damaged. In addition, it is also ensured that there is a spacing between the extension portion 242 and the protective film 220 disposed on the side wall of the cell 201, avoiding friction between the extension portion 242 and the protective film 220 located on the side wall of the cell 201 and damage to the protective film 220.

A cross section of the extension portion 242 in a direction perpendicular to the first direction X may have a straight shape, a wavy shape, an arc shape, or the like, as long as the protective film 220 in the second region 212 can be covered, thereby further reducing the probability of damage of the protective film 220. In addition, the extension portion 242 has a spacing from the protective film 220 located on the side surface of the cell assembly 210, and any portion of the extension portion 242 does not abut against the protective film 220 located on the side surface of the cell assembly 210. Therefore, it is possible to avoid generation of frictional force between the extension portion 242 and the protective film 220 located on the side wall of the cell 201, and avoid increase of the probability of damage of the protective film 220 located on the side wall of the cell 201.

Specifically, the spacing between the extension portion 242 and the at least one protective film 220 on the side surface of the cell assembly 210 is in a range of 0.5 mm to 1 mm, specifically, 0.5 mm to 0.6 mm, 0.6 mm to 0.7 mm, 0.7 mm to 0.8 mm, 0.8 mm to 0.9 mm, or 0.9 mm to 1.0 mm. Within this length range, the extension portion 242 may cover the protective film 220 located on the side surface of the cell assembly 210 close to the protective film 220 exposed in the second region 212, further reducing the probability of damage of the protective film 220. In addition, since the extension portion 242 has a thickness, when the spacing between the extension portion 242 and the protective film 220 on the side surface of the cell assembly 210 is in a range of 0.5 mm to 1 mm, the extension portion 242 does not come into contact with the protective film 220 on the side surface of the cell assembly 210, thereby avoiding damage to the protective film 220 on the side surface of the cell assembly 210 by the extension portion 242 during the installation of the CCS assembly 230 and the cell assembly 210.

The cornice portion 241 and the extension portion 242 are integrally formed, or the cornice portion 241 and the extension portion 242 are fixedly connected by welding or the like, so that the overall structure of the second portion 240 is more stable.

As shown in FIG. 6, in some embodiments, the cell module further includes fasteners 250. The fasteners 250 are disposed on an outside of the plurality of cell assemblies 210 and used to fix the cell assembly 210. A spacing between the extension portion 242 and the protective film 220 located on the side wall of the cell assembly 210 is smaller than the thickness of each fastener 250. The fasteners 250 may serve as a support structure of the cell assemblies 210, may provide a certain mechanical support force for the cell assemblies 210, maintain the overall structural stability of the cell assemblies 210, prevent the cells 201 included in the cell assembly 210 from being deformed or displaced during movement, and reduce the risk of damage to the cell assembly 210. In addition, each extension portion 242 may extend in the direction from the top surface to the bottom surface of the cell 201 to the position where a corresponding fastener 250 is located, such that the protective film 220 located on the side surface of the cell assembly 210 can be covered to a greater extent, and the stability of the protective film 220 located on the side surface of the cell assembly 210 can be further improved. Furthermore, by providing the spacing between the extension portion 242 and the protective film 220 located on the side wall of the cell 201 to be smaller than a thickness of the fastener 250, it is also possible to avoid interference between the extension portion 242 and the fastener 250, and avoid affecting stability of the overall structural of the cell module.

In some embodiments, another end of the extension portion 242 away from the cornice portion 241 abuts on a top surface of the fastener 250. Specifically, the spacing between the extension portion 242 and the protective film 220 located on the side wall of the cell 201 is smaller than the thickness of the fastener 250, and the end of the extension portion 242 away from the cornice portion 241 abuts against the top surface of the fastener 250. Therefore, the protective film 220 located on the side surface of the cell assembly 210 can be covered to a greater extent, and the extension portion 242 abuts against the fastener 250, so that the fastener 250 can provide a certain supporting force for the extension portion 242. Therefore, the extension portion 242 has a good protective effect on the protective film 220 located on the side surface of the cell assembly 210, so as to avoid damage to the protective film 220 located on the side surface of the cell assembly 210, and further avoid damage to the cell assembly 210.

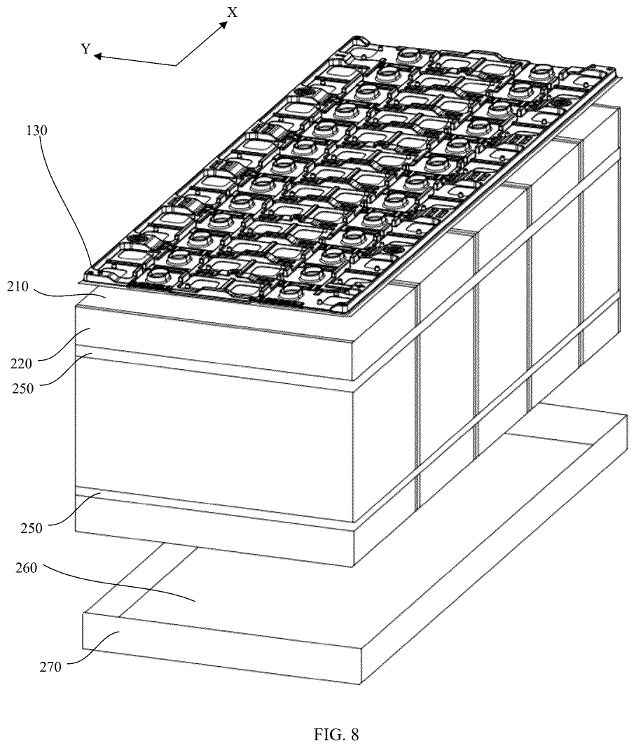

Referring to FIGS. 6 and 8, the fastener 250 may adopt a bind belt, and the cells 201 are assembled by using the bind belt to form the cell assembly 210. In some embodiments, the cells 201 may be assembled by two bind belts, where one bind belt is located at one end of the cell assembly 210 close to the first portion 231, and the other bind belt is located at one end of the cell assembly 210 away from the first portion 231, thereby making the assembly effect of the bind belts on the cells 201 stronger. In some other embodiments of the present disclosure, different assembly methods of cells may be selected according to the number of cells 201, and the type and number of fasteners 250 are not limited here. Furthermore, the material of the bind belt may be a steel belt, and the steel belt is used to bind the cells 201, which may make the structure of the cell assembly 210 formed by assembling the cells 201 more stable, and can also save costs.

In some embodiments, each second portion 240 further includes an extension portion 242 connected to another end of the cornice portion 241 away from the first portion 231. The extension portion 242 extends in a direction from the top surface to the bottom surface of the cell 201. There is a gap between the extension portion 242 and the protective film 220 located on the side wall of the cell 201. A cross section of a connection between the extension portion 242 and the cornice portion 241 in a direction perpendicular to the first direction X is a curved surface, and it is to be understood that the connection between the extension portion 242 and the cornice portion 241 is in smooth transition, which can reduce the installation risk during installation.

FIG. 7 is a side view of another embodiment of FIG. 6.

Referring in conjunction with FIGS. 3, 4, 6, and 7, in some embodiments, the extension portion 242 defines at least one through hole 2421 on a surface of the extension portion 242 facing the protective film 220. Specifically, the extension portion 242 defines a plurality of through holes 2421 uniformly on the surface of the extension portion 242 facing the protective film 220. The number of through holes 2421 and the size of each of the through holes 2421 may be set according to an area of the surface of the extension portion 242 facing the protective film 220 in the actual process, which are not limited herein. The at least one through hole 2421 is formed on the surface of the extension portion 242 facing the protective film 220, which can not only satisfy the requirement that the extension portion 242 protects the protective film 220 located on the side surface of the cell assembly 210, but also facilitate heat dissipation of the cells 201, and further improve the safety of the cell assembly 210 during operation.

Furthermore, in some embodiments, the second portion 240 has a thickness in a range of 0.3 mm to 0.8 mm, specifically, 0.3 mm to 0.4 mm, 0.4 mm to 0.5 mm, 0.5 mm to 0.6 mm, 0.6 mm to 0.7 mm, or 0.7 mm to 0.8 mm. Within this thickness range, the covering and shielding of the protective film 220 by the second portion 240 can be satisfied, the overall manufacturing cost of the CCS assembly 230 can be reduced, and excessive space occupied by the second portion 240 can be avoided.

It shall be understood that when each second portion 240 merely includes the cornice portion 241, the thickness of the second portion 240 may mean the thickness of the cornice portion 241. If each second portion 240 includes the cornice portion 241 and extension portion 242, the thickness of the second portion 240 may mean an average thickness of the thickness of the cornice portion 241 and thickness of the extension portion 242.

FIG. 8 is a structural explosion diagram of a cell module according to an embodiment of the present disclosure.

Referring to FIG. 8, in some embodiments, the cell module further includes a bottom plate 260 and four side plates 270 connected in sequence. The bottom plate 260 has opposing first side edges and opposing second side edges, where each first side edge is connected between the second side edges. Each side plate 270 is connected with a corresponding first side edge or second side edge. The four side plates 270 and the bottom plate 260 define an accommodation cavity, and the cell assembly 210 is located in the accommodation cavity. Each side plate 270 has a top surface lower than the top surface of the cell 201.

Specifically, after the installation of the cell assembly 210 and the CCS assembly 230 is completed, there may be a need to transport/handle or hoist the cell module. The bottom plate 260 and the side plates 270 are provided at the bottom of the cell assembly 210, which can prevent the protective film 220 located at the bottom of the cell assembly 210 from being collided and prevent the protective film 220 from being damaged during the handling or hoisting of the cell module, thereby reducing the probability of damage of the cell assembly 210.

Furthermore, any of the side plates 270 or the bottom plate 260 is a protective member that undergoes an electrophoresis process. Alternatively, each of the side plates 270 or the bottom plate 260 includes a protective member and an insulating film covering the surface of the protective member, where the insulating film faces the cell assembly 210. As a result, the working performance of the cell assembly 210 is avoided from being affected during handling or hoisting of the cell module, thereby affecting the service life of the cell assembly 210. The protective member may be made of metal, such as aluminum or copper, so that the protective film 220 located at the bottom of the cell assembly 210 can be protected, and the production cost of the protective member can be reduced. In some other embodiments of the present disclosure, any of the side plates 270 or the bottom plate 260 may also be made of an insulating material such as plastic or wooden board, thereby preventing the protective film 220 located at the bottom of the cell assembly 210 from being worn and avoiding affecting the working process of the cell assembly 210.

In some embodiments, the cell module further includes fasteners 250. The fasteners 250 are disposed on the outside of the cell assembly 210 and used to fix the cell assembly 210. The side plate 270 has a thickness less than or equal to the thickness of the fastener 250, and the top surface of the side plate 270 is not higher than a bottom surface of the fastener 250 facing the side plate 270. Therefore, interference between the bottom plate 260 and the side plate 270 and the fastener 250 can be avoided, and the overall structural stability of the cell module can be ensured.

In the cell module provided in the embodiments of the present disclosure, the cell assembly 210 includes cells 201 arranged along the first direction X, where each cell 201 is provided with the protective films 220 on the bottom surface and the side surfaces of the cell 201, and the protective films 220 separate the cells 201 from each other, thereby avoiding the influence of various failures of a single cell 201 on other cells 201 and avoiding interference between the cells 201. The top surface of the cell assembly 210 includes the first region 211 and the second regions 212 located the two opposite sides of the first region 211 along the second direction Y and located the two opposite sides of the first region 211 along the first direction X, and the first direction X intersects with the second direction Y. The second regions 212 are regions where the protective film 220 on the side surface of each of the cells 201 is located. The CCS assembly 230 is disposed on the top surface of each of the at least one cell assembly 210. The CCS assembly 230 includes the first portion 231 and the second portions 240, and the first portion 231 is at least partially located on the first region 211 and exposes the protective film 220 exposed in the second region 212. Each second portion 240 extends from the edge of the first portion 231 in the direction away from the at least one respective protective film 220. The orthographic projection of the respective second portion 240 on the respective second region 212 covers the respective second region 212, and the respective second portion 240 is spaced apart from the at least one respective protective film 220 exposed in the respective second region 212. It shall be understood that during the installation of the CCS assembly 230 and the cell assembly 210, the second portion 240 of the CCS assembly 230 does not come into contact with the protective film 220 exposed in the second region 212, and the second portion 240 does not rub with the protective film 220 exposed in the second region 212, so that the protective film 220 exposed in the second region 212 is avoided from being scratched by the second portion 240. In addition, the second portion 240 is located over the top of the protective film 220, and the protective film 220 can also be avoided from being in contact with other external components, so that the stability of the cell assembly 210 wrapped by the protective film 220 can be further improved.

According to some embodiments of the present disclosure, another aspect of the embodiment of the present disclosure further provides an energy storage pack (or cell pack), which includes the cell module as in any of the above embodiments.

Specifically, the cell pack includes cells arranged in a predetermined direction and a CCS assembly corresponding to the cells, thereby improving the working efficiency of the cell assembly and realizing efficient utilization of energy.

In other embodiments of the present disclosure, a cell pack is provided, including a cell module and a housing. The housing is provided with mounting beams at a base of the housing, where a mounting position is formed between each two mounting beams. The cell module includes cell assemblies, end plates, and at least one cushioning assembly. Each end plate is provided at an end of a corresponding cell assembly. Each end plate is connected to a corresponding mounting beam at a bottom of the end plate so that a respective cell assembly is mounted at a respective mounting position, where at least part of a side wall surface of the cell assembly and the mounting beam form a first cushioning region, and at least part of a bottom surface of the cell assembly and the base form a second cushioning region. Each cushioning assembly is formed by extending from a bottom of the end plate. The cushioning assembly includes a first cushioning plate and a second cushioning plate, where the second cushioning plate is bent and extends in a horizontal direction from an end of the first cushioning plate away from the end plate. The first cushioning plate is disposed in the first cushioning region in a vertical direction, and the second cushioning plate is disposed in the second cushioning region in a horizontal direction.

In some embodiments, the first cushioning plate and the second cushioning plate are straight plate structures, a corrugated plate structures, or a combination structure of a straight plate and a corrugated plate.

In some embodiments, the first cushioning plate and the second cushioning plate are hollow structures.

In some embodiments, the first cushioning plate and the second cushioning plate each are provided with a cushioning layer, and the cushioning layer is at least one of an elastic material layer and a damping material layer.

In some embodiments, the end plate includes at least two extension members, and the at least two extension members are spaced at a bottom of the end plate in an extension direction of the mounting beam.

The extension member includes a first cushioning plate and a second cushioning plate arranged at an angle.

In some embodiments, a horizontal distance between an end of the first cushioning plate away from the second cushioning plate and the mounting beam is in a range of 0.5 mm to 2 mm.

In some embodiments, a thickness of the second cushioning plate in the vertical direction is in a range of 0.5 mm to 1 mm.

In some embodiments, an extension length of the second cushioning plate in the horizontal direction is in a range of 5 mm to 20 mm.

In some embodiments, the cushioning assembly further includes an elastic buffer structure, where the elastic buffer structure is disposed at a junction of the first cushioning plate and the second cushioning plate, and the elastic buffer structure abuts on a bottom corner of the cell assembly.

In addition, embodiments of the present disclosure further provide an energy storage device, where the energy storage device includes a battery management system, an electrical system, a thermal management system, and the cell pack according to any one of the above embodiments.

The technical solution of the present disclosure has at least the following beneficial effects:

In the cell pack provided in the present disclosure, the bottom of the end plate extends to form a cushioning assembly, and the cushioning assembly includes the first cushioning plate and the second cushioning plate. The first cushioning plate is disposed between the side wall of the cell assembly and the mounting beam, and the second cushioning plate is disposed between the bottom of the cell assembly and the base. In addition, the junction of the first cushioning plate and the second cushioning plate is abutted with the corner of the cell assembly. That is, through the cooperation of the first cushioning plate and the second cushioning plate, the lower end of the cell assembly close to the mounting beam can be protected, without providing an additional protective structure such as corner protection, which can reduce the weight of cell packs and reduce production costs.

Energy storage devices refer to devices that can store and release electric energy. The energy storage device mainly includes the battery management system, the electrical system, the structural parts, the thermal management system, and the cell pack that are important components of the energy storage device. The battery management system is responsible for monitoring an operating status of the cell pack, including a voltage, a current, a temperature, and other parameters of each cell, and avoiding overcharge, over-discharge, overheating, short circuit and other damages of the cell pack by balancing charging, controlling the charging and discharging process, thereby prolonging the life of the cell pack and ensuring the safe and stable operation of the entire energy storage system.

The electrical system includes all electrical components and circuits inside the energy storage device, such as series-parallel connections between cells, interfaces for inverters or chargers, connection equipment with power grids or loads, control circuits, and the like. The electrical system ensures efficient power conversion and transmission between energy storage device and external power sources or loads.

The thermal management system is a key system to ensure that the cell pack works within a suitable temperature range. An internal temperature of the cell pack can be monitored and controlled through radiators, coolants, fans, thermistors, and other components. When the battery generates heat during charging or discharging, the thermal management system can dissipate heat in a timely and effective manner to avoid performance degradation or safety problems due to battery overheating.

The cell pack includes a cell module and a housing. The cell module includes a cell assembly and end plates arranged at both ends of the cell assembly. The cell assembly includes a plurality of cell units (cells) connected in series or in parallel, and each cell is provided with at least one positive electrode tab and at least one negative electrode tab. When the cells are connected in series, the plurality of cells are sequentially welded or bonded according to the sequence of alternating connection of the positive electrode tabs and the negative electrode tabs to obtain a cell series group with high total voltage. When the cells are connected in parallel, the positive electrode tabs of the plurality of cells are welded or bonded and the negative electrode tabs of the plurality of cells are welded or bonded to obtain a cell parallel group with high total capacity. The arrangement of cells in the cell assembly can be selected according to the voltage and capacity requirements of the cell pack, which is not limited herein.

The end plate can provide mechanical support for the cell assembly, ensure the stability of the cell assembly during transportation and use, and prevent structural damage caused by vibration or impact. The end plate is generally made of metal materials such as aluminum, stainless steel, or composite materials. The arranged cell assemblies can be connected with the end plate to form the cell module. Specifically, the end plate is provided with conductive parts such as solder pads or binding post (terminals), and the positive and negative electrode tabs of the cell assemblies are welded with the pads or terminals on the end plates by using conductive parts such as steel strips through laser welding, ultrasonic welding and the like, so as to realize the electrical connection between the cell assemblies and the end plate to obtain the cell module.

After the cell assemblies are connected to the end plates, in order to ensure the safety and durability of the cell pack, the cell assemblies need to be packaged. The packaging materials can include thermoplastic materials, epoxy resins, or the like. The cell assemblies are packaged by wrapping through packaging films, to prevent short circuits between the cell assemblies and erosion hazards to the cell assemblies caused by external moisture and dust during the use of the cell pack.

The packaged cell module can be placed in the housing. The housing is generally made of a high-strength, corrosion-resistant material to protect the internal cell module from mechanical impact and external environment. Specifically, the housing is provided with mounting beams at a base of the housing, and a mounting position is formed between the mounting beams. A size of the mounting position matches the size of the cell module. The end plates of the cell module are aligned with the mounting beams during installation, and then the end plates and the mounting beams are connected by high-strength bolts, nuts, or other special fasteners, so that the cell module is fixed in the mounting position.

However, during the assembly of the above-mentioned cell pack, a lower end of the cell assembly close to the mounting beam is easy to collide with the mounting beam and then to be damaged, thus affecting the use of the cell pack.

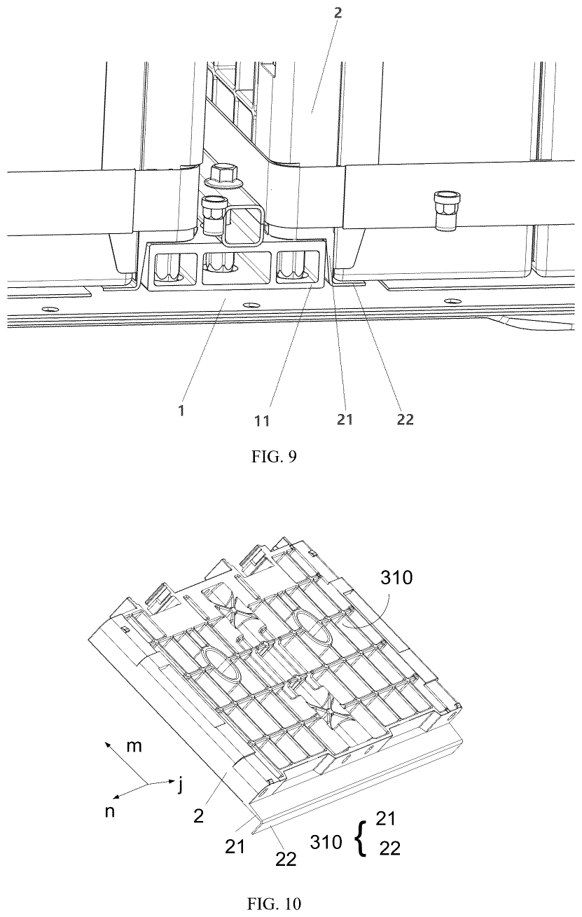

In view of this, the present disclosure provides a cell pack. Please refer to FIGS. 9 and 10, the cell pack includes the cell module and the housing 1, and the housing 1 is provided with mounting beams 11 at a base of the housing 1, where a mounting position is formed between each two mounting beams 11. The cell module includes cell assemblies 310, end plates 2, and at least one cushioning assembly 320.

Each end plate 2 is provided at an end of a corresponding cell assembly. Each end plate 2 is connected to a corresponding mounting beam 11 at a bottom of the end plate 2 so that a respective cell assembly is mounted at a respective mounting position, where at least part of a side wall surface of the respective cell assembly and the mounting beam 11 form a first cushioning region, and at least part of a bottom surface of the respective cell assembly and the base form a second cushioning region.

Each cushioning assembly 320 is formed by extending from a bottom of the end plate 2. The cushioning assembly 320 includes a first cushioning plate 21 and a second cushioning plate 22. The second cushioning plate 22 is bent and extends in a horizontal direction n from an end of the first cushioning plate 21 away from the end plate 2. The first cushioning plate 21 is disposed in the first cushioning region in a vertical direction m, and the second cushioning plate 22 is disposed in the second cushioning region in the horizontal direction n.

In the above cell pack, the bottom of the end plate 2 extends to form the cushioning assembly. The cushioning assembly includes the first cushioning plate 21 and the second cushioning plate 22. The first cushioning plate 21 is disposed between the side wall of the cell assembly and the mounting beam 11, and the second cushioning plate 22 is disposed between the bottom of the cell assembly and the base. A junction of the first cushioning plate 21 and the second cushioning plate 22 is abutted with the corner of the cell assembly. That is, the lower end of the cell assembly close to the mounting beam 11 can be protected through the cooperation of the first cushioning plate 21 and the second cushioning plate 22. In addition, there is no need to provide additional protective structures such as corner guards, reducing the weight of the cell pack and lowering production costs.

In some embodiments, the first cushioning plate 21 is inclined in the first cushioning region.

The first cushioning plate 21 is inclined in the first cushioning region, which may mean that an angle between the first cushioning plate 21 and the second cushioning plate 22 is an acute angle or an obtuse angle. For example, the angle between the first cushioning plate 21 and the second cushioning plate 22 is an acute angle, which means that the lower end of the first cushioning plate 21 close to the second cushioning plate 22 is closer to the cell assembly than an upper end of the first cushioning plate 21 away from the second cushioning plate 22. That is, a horizontal distance between the lower end of the first cushioning plate close to the second cushioning plate and the cell assembly is relatively smaller. When a force is applied to the first cushioning plate 21 during the installation of the cell assembly, the first cushioning plate 21 can undergo a certain deformation and move along a thickness direction of the end plate (in direction n of FIG. 10), which provides a good buffering effect and reduces the bumping of the cell assembly.

In some embodiments, when the end plate 2 of the cell module of the present disclosure is connected to the mounting beam 11, a width of the end plate 2 is slightly larger than a width of the mounting beam 11 in an extension direction of the second cushioning plate 22. In this case, the end surface of the cell assembly, the side wall surface of the mounting beam 11, the surface of the base, and the bottom surface of the end plate 2 define the first cushioning region. It shall be understood that the first cushioning region is provided to enable that the corner of the cell assembly is separated from the mounting beam 11 by a certain distance, and collision between the corner of the lower end of the cell assembly and the mounting beam 11 can be reduced. The second cushioning region is formed between the bottom surface of the cell assembly and the surface of the base. It shall be understood that providing the second cushioning region can reduce the collision between the corner of the lower end of the cell assembly and the surface of the base.

It is to be noted that there is no restriction on sizes of the first cushioning region and the second cushioning region, which can be adjusted according to the sizes of the end plate 2, the mounting beam 11, and the cell assembly, so as to ensure the mounting of the cushioning assembly.

In some embodiments, the cushioning assembly is formed by extending from the bottom of the end plate 2. That is, the cushioning assembly and the end plate 2 are integrally formed. It shall be understood that the bottom of the end plate 2 extends downward to form the first cushioning plate 21. The first cushioning plate 21 is installed in the first cushioning region along the vertical direction to block the collision of the corner of the cell assembly in the horizontal direction. The first cushioning plate 21 is bent in the horizontal direction and extends at the end of the first cushioning plate 21 away from the bottom of the end plate 2 to form the second cushioning plate 22. The second cushioning plate 22 is mounted in the second cushioning region in the horizontal direction for blocking the corners of the cell assembly from collision in the vertical direction.

As an optional technical solution of the present disclosure, when the bottom of the end plate 2 is extended to form the cushioning assembly 320, a length of the cushioning assembly is the same as a length of the end plate 2 along a longitudinal/extension direction j of the mounting beam 11. That is, the bottom of the entire end plate 2 is provided with the cushioning assembly.

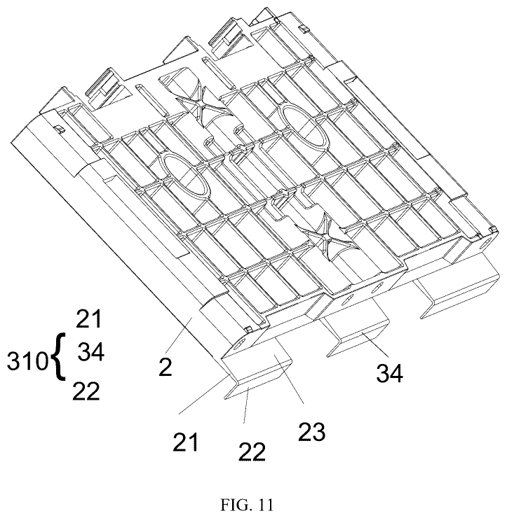

As another optional technical solution of the present disclosure, referring to FIG. 11, a partial region of the bottom of the end plate 2 extends to form the cushioning assembly. That is, the end plate 2 includes at least two extension members 23, and each extension member 23 includes the first cushioning plate 21 and the second cushioning plate 22 arranged at an angle. The end plate 2 may include two extension members 23, three extension members 23, or five extension members 23, or the like. In the extension direction j of the mounting beam 11, the extension members 23 are disposed at equal intervals at the bottom of the end plate 2 to ensure that the extension members 23 can play a uniform cushioning effect. The region for providing the cushioning assembly at the bottom of the end plate 2 and the width and number of the extension members 23 can be selected according to actual needs, which are not limited herein.

It is to be noted that when two or more extension members 23 are provided at the bottom of the end plate 2, the extension members 23 are provided at both ends of the bottom of the end plate 2 along the longitudinal direction j of the mounting beam 11, so as to play a cushioning role on the corners of the cell assembly.

The first cushioning plate 21 and the second cushioning plate 22 used in the present disclosure are straight plate structures, corrugated plate structures, or a combined structure of a straight plate and a corrugated plate. When the first cushioning plate 21 and the second cushioning plate 22 are the straight plate structures (the cross section of the straight plate structure may be a plate body with uniform thickness variation), the structure of the cushioning assembly is simple, and uniform support and buffer effect can be provided. When the first cushioning plate 21 and the second cushioning plate 22 are the corrugated plate structures, the surface of the corrugated plate has periodically undulating corrugations, and this design can provide good energy absorption and pressure dispersion effects, and improve the cushioning effect of the cushioning assembly. When the first cushioning plate 21 and the second cushioning plate 22 are the combined structure of the straight plate and the corrugated plate, the straight plate of the cushioning assembly can provide uniform support and cushioning effect, and the corrugated plate can increase the cushioning capacity of the cushioning assembly. The type of the cushioning plate can be selected according to the actual needs, which is not limited here.

Furthermore, the first cushioning plate 21 and the second cushioning plate 22 are hollow structures for enhancing the cushioning effect of the cushioning assembly. It shall be understood that the hollow structures can greatly reduce the amount of material of the cushioning assembly, thereby reducing the overall weight of the cushioning assembly. Moreover, the hollow structures can be slightly deformed when stressed, so as to achieve good stress absorption and dispersion and enhance the cushioning effect. In addition, the hollow structures can enhance the gas circulation between the end plate 2 and the cell assembly, improve the heat dissipation efficiency of the cell module, prevent the internal heat accumulation of the cell module, and prolong the service life of the cell pack.

Furthermore, the first cushioning plate 21 and the second cushioning plate 22 each are provided with a cushioning layer. The cushioning layer is at least one of an elastic material layer and a damping material layer, and is used to further enhance the cushioning effect of the cushioning assembly. It shall be understood that the elastic material layer has good elastic recovery performance and can quickly recover to the original state after being deformed by force. The damping material layer can absorb the impact force generated by collision or vibration, and convert kinetic energy into heat energy to slow down the influence of vibration or impact. The elastic material layer used in the present disclosure can be rubber, silica gel, polyurethane, etc., and the damping material layer can be a polymer damping material, a viscoelastic damping material, etc. The type and thickness of the cushioning layer can be selected according to the specifications of the cell assembly, which are not limited herein.

In some embodiments, the first cushioning plate 21 is provided in the first cushioning region along the vertical direction m. A horizontal distance between an end of the first cushioning plate 21 away from the second cushioning plate 22 and the mounting beam 11 is in a range of 0.5 mm to 2 mm. That is, the horizontal distance between a top end of the first cushioning plate 21 and the mounting beam 11 is in a range of 0.5 mm to 2 mm. Optionally, the horizontal distance between the end of the first cushioning plate 21 away from the second cushioning plate 22 and the mounting beam 11 may be 0.5 mm, 0.7 mm, 0.9 mm, 1.1 mm, 1.3 mm, 1.5 mm, 1.7 mm, 2 mm, or the like, or may be other values within the range, which may be selected according to actual needs, and is not limited herein.

If the horizontal distance between one end of the first cushioning plate 21 away from the second cushioning plate 22 and the mounting beam 11 is too small, the space between the first cushioning plate 21 and the mounting beam 11 for cushioning is small, and the first cushioning plate 21 could not play a good buffer effect. If the horizontal distance between the end of the first cushioning plate 21 away from the second cushioning plate 22 and the mounting beam 11 is too large, the thickness of the first cushioning plate 21 is too thin, the strength of the first cushioning plate 21 is reduced, and the cell pack is easily damaged due to collision or vibration during use, which affects the service life of the cell pack. In addition, the first cushioning plate 21 is closer to the cell assembly, and the extension distance to the cell assembly is too large, which affects the installation of the cell assembly. The horizontal distance between one end of the first cushioning plate 21 of the present disclosure away from the second cushioning plate 22 and the mounting beam 11 is within the above range, and the first cushioning plate 21 can play a good cushioning effect.

In some embodiments, in a direction from the bottom of the end plate to the second cushioning plate 22, the thickness of the first cushioning plate 21 gradually decreases.

It shall be understood that the thinner the thickness of the first cushioning plate 21, the more likely it is to bend and deform when subjected to a same load. Therefore, in the direction from the bottom of the end plate to the second cushioning plate 22, the thickness of the first cushioning plate 21 gradually decreases, which indicates that the thickness of the first cushioning plate 21 away from the end plate is thinner. Therefore, the cushioning assembly achieve the better buffering effect during installation, which can protect the lower end of the cell assembly near the mounting beam 11 without the need for additional protective structures such as corner protectors, reducing the weight of the cell pack and reducing production costs.

In some embodiments, the thickness of the second cushioning plate 22 in the vertical direction m is in a range of 0.5 mm to 1 mm. Optionally, the thickness of the second cushioning plate 22 in the vertical direction m may be 0.5 mm, 0.6 mm, 0.7 mm, 0.8 mm, 0.9 mm, 1 mm, or the like, or may be other values within the range, which may be selected according to actual needs, and is not limited herein. If the second cushioning plate 22 is too thin, the strength of the second cushioning plate 22 is reduced, and the cell pack is easily damaged due to collision or vibration during use of the cell pack, and the service life of the cell pack is affected. If the second cushioning plate 22 is too thick, the second cushioning plate 22 may lift up the cell assembly too much, which may affect the packaging and usage process of the cell assembly. The thickness of the second cushioning plate 22 used in the present disclosure is within the above range, and the weight of the second cushioning plate 22 is appropriate while not affecting the installation of the cell assembly.

As an optional technical solution of the present disclosure, a mounting groove is defined in a portion of the base abutting on the second cushioning plate 22, and the second cushioning plate 22 can be installed in the mounting groove. When the second cushioning plate 22 is installed in the mounting groove, a top surface of the second cushioning plate 22 is substantially flush with the top of the mounting groove. It shall be understood that after the mounting groove is provided, it can be ensured that the surface height of the base in contact with the cell assembly is uniform after the second cushioning plate 22 is installed, the cell is prevented from being lifted up, and the coating of the adhesive is convenient.

An extension length of the second cushioning plate 22 in the horizontal direction is in a range of 5 mm to 20 mm. Optionally, the extension length of the second cushioning plate 22 in the horizontal direction may be 5 mm, 7 mm, 9 mm, 11 mm, 13 mm, 15 mm, 17 mm, 19 mm, 20 mm, or the like, or may be other numerical values within the range, and may be selected according to actual needs, which is not limited herein. If the extension length of the second cushioning plate 22 is too small, the second cushioning plate 22 is easily separated from the second cushioning region when the first cushioning plate 21 is deformed in a direction away from the cell assembly, and the buffer effect of the second cushioning plate 22 is ineffective. If the extension length of the second cushioning plate 22 is too long, the installation of the cell assembly may be affected. The extension length of the second cushioning plate 22 of the present disclosure is within the above range, which does not affect the installation of the cell assembly, and can also play a good buffer effect.

In some embodiments, the cushioning assembly further includes an elastic buffer structure 34. The elastic buffer structure 34 is disposed at a junction of the first cushioning plate 21 and the second cushioning plate 22, and the elastic buffer structure 34 abuts on a bottom corner of the cell assembly. It shall be understood that when the bottom corner of the cell assembly is collided, worn of the encapsulation film or damage of the cell assembly are more likely to occur in the remaining parts of the cell assembly. After the elastic buffer structure 34 is provided, on the basis of the first cushioning plate 21 and the second cushioning plate 22, it is possible to further prevent hard contact between the bottom corner of the cell assembly and the mounting beam 11, reduce the wear phenomenon, and maintain the structural integrity of the cell assembly. The elastic buffer structure 34 used in the present disclosure may be a rubber protrusion, a silicone protrusion, a polyurethane protrusion, or the like provided at the junction of the first cushioning plate 21 and the second cushioning plate 22, and may be selected according to actual needs, which is not limited herein.

In the actual process, the cell module is first formed by assembling the cell assembly with the end plate 2 through a conductive member such as a steel strip, and then the cell module is fixed in the mounting position of the housing 1 through fit of the end plate 2 and the mounting beam 11. In this case, the first cushioning plate 21 is blocked between the side wall of the cell assembly and the mounting beam 11, the second cushioning plate 22 is blocked between the bottom of the cell assembly and the base, and the elastic buffer structure 34 is abutted with the corner of the cell assembly. That is, the lower end of the cell assembly close to the mounting beam 11 can be protected through the cooperation of the first cushioning plate 21, the second cushioning plate 22, and the elastic buffer structure 34, to prevent the corner of the cell assembly from being damaged by collision or vibration.

It is to be noted that in the embodiments provided in FIGS. 1 to 11, similar elements may use different terminology or different reference numerals (e.g., energy storage pack and cell pack; cell unit and cell), but the location and function are similar, respectively, and the details of each embodiment can be implemented in cooperation with each other without conflicting.

It shall be understood by those skilled in the art that the above-described embodiments are specific embodiments for implementing the present disclosure, and that various changes in form and details can be made thereto in practical application without departing from the spirit and scope of the present disclosure. Any person skilled in the art can make various changes and modifications without departing from the spirit and scope of the present disclosure, and therefore, the scope of protection of the present disclosure should be based on the scope defined by the claims.

What is claimed is:

1. A cell pack, comprising:
a plurality of cell assemblies, wherein each cell assembly of the plurality of cell assemblies includes cells arranged in a first direction, and each cell of the cells has a top surface, a bottom surface, and side surfaces of the cell, each of the side surfaces adjoining the top surface and the bottom surface, each of the bottom surface and the side surfaces being provided with a protective film, wherein a top of the each cell assembly has a first region corresponding to the top surfaces of the cells and second regions corresponding to edges of protective films on outward-facing side surfaces of the cells, the first region having two opposite edges extending in the first direction and two opposite edges extending in a second direction, each of the second regions abutting a respective edge of the first region, and wherein the first direction traverses the second direction; and
at least one cells contact system (CCS) assembly respectively disposed on the top of at least one cell assembly of the plurality of cell assemblies, wherein each respective CCS assembly of the at least one CCS assembly includes a first portion located at least partially on the first region of a respective cell assembly of the at least one cell assembly and second portions, a respective second portion of the second portions corresponds to a respective second region of the second regions of the respective cell assembly and extends from a corresponding edge of the first portion in a direction away from at least one respective protective film in the respective second region, and an orthographic projection of the respective second portion on the respective second region covers the respective second region.

2. The cell pack of claim 1, wherein the respective second portion is spaced apart from the at least one respective protective film exposed in the respective second region.

3. The cell pack of claim 1, wherein the respective second portion includes:
a cornice portion having an end connected to the corresponding edge of the first portion, wherein an orthographic projection of the cornice portion on the respective second region covers the at least one respective protective film exposed in the respective second region.

4. The cell pack of claim 3, wherein a length of the orthographic projection of the cornice portion on the respective second region in the second direction is in a range of 0.2 mm to 1.8 mm.

5. The cell pack of claim 3, wherein an angle between a surface of the cornice portion facing the at least one respective protective film and a surface of the at least one respective protective film facing the cornice portion is an acute angle.

6. The cell pack of claim 3, wherein at least one step is formed between the cornice portion and the first portion.

7. The cell pack of claim 6, wherein the cornice portion has a first connection portion and a second connection portion, and each of the first connection portion and the second connection portion has two opposite ends, wherein the first connection portion has an end connected to the first portion and extending in a direction perpendicular to the top of the cell assembly, and the first connection portion has another end connected to an end of the second connection portion, and the second connection portion extends in the first direction;
wherein an orthographic projection of the second connection portion on the respective second region covers the at least one respective protective film exposed in the respective second region.

8. The cell pack of claim 3, wherein the respective second portion further comprises:
an extension portion connected to another end of the cornice portion away from the first portion, wherein the extension portion extends in a direction from the top surface to the bottom surface of the cell, and the extension portion is spaced apart from the at least one respective protective film exposed in the respective second region.

9. The cell pack of claim 8, wherein the extension portion is spaced apart from the at least one respective protective film by a distance in a range of 0.5 mm to 1 mm.

10. The cell pack of claim 8, wherein the cell pack further comprises:
at least one fastener disposed on an outer side of the plurality of cell assemblies and configured for fixing the plurality of cell assemblies, wherein a spacing between the extension portion and the at least one respective protective film exposed in the respective second region is less than a thickness of a respective fastener of the at least one fastener.

11. The cell pack of claim 8, wherein the extension portion abuts on a top surface of a corresponding fastener at an end of the extension portion away from the cornice portion.

12. The cell pack of claim 8, wherein the extension portion defines at least one through hole on a surface of the extension portion facing the at least one respective protective film.

13. The cell pack of claim 1, wherein the first portion and the second portions are integrally formed.

14. The cell pack of claim 1, wherein the respective second portion has a thickness in a range of 0.3 mm to 0.8 mm.

15. The cell pack of claim 1, wherein the cell pack further comprises:
a bottom plate having opposing first side edges and opposing second side edges, wherein each first side edge is connected between the second side edges; and
four side plates connected sequentially, wherein each side plate is connected with the corresponding first side edge or second side edge, and the four side plates and the bottom plate define an accommodating cavity, wherein the each cell assembly is located in the accommodating cavity, and each side plate has a top surface lower than the top surfaces of the cells.

16. The cell pack of claim 15, wherein the cell pack further comprises:
at least one fastener disposed on an outer side of the plurality of cell assemblies and configured for fixing the plurality of cell assemblies;
wherein each side plate has a thickness less than or equal to a thickness of a respective fastener, and has a top surface not higher than a bottom surface of the respective fastener facing the side plate.

17. The cell pack of claim 15, wherein each of the side plates or the bottom plate is a protective member undergoing an electrophoresis process; or
wherein each of the side plates or the bottom plate includes a protective member and an insulating film covering a surface of the protective member, the insulating film facing the cell assembly.

18. The cell pack of claim 1, wherein the cell pack further comprises:
a housing provided with mounting beams at a base of the housing, wherein a mounting position is formed between each two mounting beams;
end plates, wherein each end plate is provided at an end of a corresponding cell assembly of the plurality of cell assemblies, and is connected with a corresponding mounting beam at a bottom of the end plate so that a respective cell assembly is mounted at a respective mounting position, wherein at least part of a side wall surface of the cell assembly and the mounting beam form a first cushioning region, and at least part of a bottom surface of the cell assembly and the base form a second cushioning region; and
at least one cushioning assembly, wherein a respective cushioning assembly of the at least one cushioning assembly is formed by extending from a bottom of the respective end plate, and the respective cushioning assembly includes a first cushioning plate and a second cushioning plate, wherein the second cushioning plate is bent and extends in a horizontal direction from an end of the first cushioning plate away from the end plate, the first cushioning plate is disposed in the first cushioning region in a vertical direction, and the second cushioning plate is disposed in the second cushioning region in a horizontal direction.

19. The cell pack of claim 18, wherein the first cushioning plate and the second cushioning plate are straight plate structures, a corrugated plate structures, or a combination structure of a straight plate and a corrugated plate.

20. The cell pack of claim 18, wherein a horizontal distance between an end of the first cushioning plate away from the second cushioning plate and the mounting beam is in a range of 0.5 mm to 2 mm.
